(19) United States
(12) Patent Application Publication
(10) Pub. No.: US 2014/0280046 A1
(43) Pub. Date: Sep. 18, 2014

(54) SEARCHING USING SOCIAL FILTERS AS OPERATORS

(71) Applicant: MICROSOFT CORPORATION, Redmond, WA (US)

(72) Inventors: Meir Ben Itay, Sammamish, WA (US); Min Liu, Redmond, WA (US); Daniel Buchmueller, Seattle, WA (US); Jose Saura, Kent, WA (US); Gur Kimchi, Bellevue, WA (US)

(73) Assignee: MICROSOFT CORPORATION, Redmond, WA (US)

(21) Appl. No.: 13/827,654

(22) Filed: Mar. 14, 2013

(51) Int. Cl. G06F 17/30

(52) U.S. Cl. CPC G06F 17/30554
USPC 707/722

(57) ABSTRACT

Systems, methods, and computer-readable media for responding to a search query with search results where the search query includes a social source operation are presented. Upon receiving a search query directed to a query topic, and including a social source operation, the search engine identifies search results corresponding to the query topic, and further obtains social data necessary to satisfy the social source operation of the search query. The search results are modified in light of the social source operation according to the obtained social data. One or more search results pages are generated according to the modified search results and at least one of the search results pages is returned to the requesting computer user.

### BACKGROUND

Search engines have become a common resource of information for many people. In the typical scenario, a computer user submits a search query (via a user computer) to a search engine, where the search query identifying the subject matter for which information is sought by the computer user. The search engine identifies search results, including hyperlinks to online content related to the search query, generates one or more search results pages containing the identified search results, and returns the search results pages to the computer user in response to the search query.

More often than not, the query topic (the topic of the search query) is little more than a broad topic. As a result, the number of search results related to the query topic is extremely large. In circumstances where the number of search results is large, while the search engine is able to generate search results pages that include all of the search results, it is entirely unrealistic for the computer user to review all of the search results to find the desired content. To get a more manageable set of search results, the computer user must, therefore, narrow the scope of the search query. One means for narrowing the scope of the search query is to provide operators (and operands) that restrict and/or filter the search results to a more management set. For example, to limit search results corresponding to a search query on recent presidential debates, a computer user might submit a search query with an operator (and corresponding operand) “>=2012”, thereby indicating that only search results from the year 2012 and later should be included.

For their part, search engines are configured to present the most relevant search results first to the computer user, i.e., including the most relevant search results in the first search results pages. The process of determining the most relevant search results has been (and continues to be) an area of substantial innovation and effort. On factor in determining relevancy is to evaluate the search results in light of information relating to the requesting computer user, such as the computer user's explicit and implicit preferences as well as those preferences of people and groups in the computer user's social network. However, while some search engines may consider user related information in determining relevance of search results, search engines have failed to permit computer users to control what user related should be used in determining relevance by way of operators.

### SUMMARY

The following Summary is provided to introduce a selection of concepts in a simplified form that are further described below in the Detailed Description. The Summary is not intended to identify key features or essential features of the claimed subject matter, nor is it intended to be used to limit the scope of the claimed subject matter.

According to aspects of the disclosed subject matter, a method for responding to a search query that includes a social source operation is presented. Upon receiving the search query, search results corresponding to the query topic of the search query are obtained. The obtained search results are formed such that they satisfy the social source operation of the search query. One or more search results pages are generated based on the obtained search results and at least one of the generated search results pages is returned to the requesting computer user.

According to further aspects of the disclosed subject matter, computer-readable media bearing computer-executable instructions is presented. The computer-executable instructions, when executed on a computing device comprising both a processor and a memory, carry out a method for responding to a search query that includes a social source operation. The method comprises at least the steps of: receiving a search query that includes a social source operation; obtaining search results corresponding to the query topic of the search query and that satisfies the social source operation; generating at least one search results page that includes the obtained search results; and returning the at least one search results page to the requesting computer user.

According to still further aspects of the disclosed subject matter, a computer system for responding with search results to a search query that includes a social source operation is presented. The computer system includes a processor and a memory, wherein the processor executes instructions stored in the memory as part of or in conjunction with additional components to respond to a search query. Included in the computer system is a search results retrieval component that identifies a plurality of search results responsive to a query topic of the search query. A social data retrieval component is configured to obtain social data from an internal source and/or one or more external sources via a network communication component. A search results combination component applies the social source operation to the search results identified by the search results retrieval component according to the social data obtained by the social data retrieval component, thereby generating a revised set of search results. A search results page generator generates one or more search results pages based on the revised set of search results and returns at least one generated search results page to the computer user in response to the search query.

### BRIEF DESCRIPTION OF THE DRAWINGS

The foregoing aspects and many of the attendant advantages of the disclosed subject matter will become more readily appreciated as they are better understood by reference to the following description when taken in conjunction with the following drawings, wherein:

FIG. 1 is a block diagram illustrating an exemplary networked environment suitable for implementing aspects of the disclosed subject matter;

FIG. 2 is a block diagram illustrating the flow of information between various components, including the computer user, the search engine and one or more social sites, with regard to a search query that includes one or more social source operations;

FIG. 3 is a flow diagram illustrating an exemplary routine for responding to a search query from a computer user where the search query includes a social source operation;

FIG. 4 is a block diagram illustrating exemplary components of a search engine suitably configured to respond to a search query from a computer user, where the search query includes a social source operation; and

FIG. 5 is a flow diagram illustrating an exemplary alternative routine for responding to a search query from a computer user with conditions for implying one or more social source operations; and

FIG. 6 is a pictorial diagram illustrating an exemplary user interface showing an example of contemporaneous queries to determine a social source for data.

### DETAILED DESCRIPTION

For purposed of clarity, the use of the term “exemplary” in this document should be interpreted as serving as an illustration or example of something, and it should not be interpreted as an ideal and/or a leading illustration of that thing.

A social source operation is an expression that qualifies the subject matter of a search query, i.e., the query topic, based on information relating to one or more other people (a social source.) While a computer user will often explicitly identify a social source operation in relation to a search query, in various embodiments a social source operation may be implicitly identified, i.e., implied according to a particular context. Typically, but not always, a social source operation is comprised of operators and operands relating to or identifying a social source. Examples of social source operations will be set forth in the following description.

Turning to the figures, FIG. 1 is a block diagram illustrating an exemplary networked environment 100 suitable for implementing aspects of the disclosed subject matter, including responding to a computer user's search query that is qualified by a social source operation. The illustrative networked environment 100 includes one or more user computers, such as user computers 102-106, connected to a network 108, such as the Internet, a wide area network or WAN, and the like. Also connected to the network 108 is a search engine 110 configured to provide search results in response to search queries received from one or more computer users, such as computer user 101 by way of user computer 102 over the network 108. According to aspects of the disclosed subject matter, the search results provided to the computer user from the search engine 110 in response to a search query will be modified according to one or more social source operations identified in the search query.

Those skilled in the art will appreciate that, generally speaking, a search engine 110 corresponds to an online service hosted on one or more computers, or computing systems, located and/or distributed throughout the network 108. The search engine 110 receives and responds to search queries submitted over the network 108 from various computer users, such as computer user 101 using user computer 102 over the network 108. In particular, responsive to receiving a search query from a computer user, the search engine 110 obtains search results information related and/or relevant to the received search query (as defined by the terms of search query.) The search results information includes search results, i.e., references (typically in the form of hyperlinks) to relevant and/or content available at various network locations located throughout the network 108, such content sites 112-116. The content sites may include (by way of illustration and not limitation): news outlets/portals/sources, such as news content site 112; online shopping sites, such as online shopping site 114; social media and networking sites, such as social site 116; educational and research sites (not shown); and the like.

According to aspects of the disclosed subject matter, the search engine 110 may have established relationships with any number of network sites and social services which can be used in responding to a search query identifying one or more social source operations. For example, the search engine 110 may include relationships with the online shopping site 114, social site 116, news content site 112, restaurants, or any number of other network sites. Thus, as part of responding to a search query from a computer user, such as computer user 101, the search engine 110 determines whether the search query includes one or more social source operations. As will be described in greater detail below, depending on the particular social source operation(s), the search engine 110 may already have enough information to satisfy the search query including social data to fully apply the social source operation(s), may need to obtain additional social data from other network sites including those with which a relationship has been established, or combine information in the search engine's content store with social data. Social data corresponds to information/data that has a social nature that is needed to complete the social source condition of the search query. When social data is obtained from external sources, it is often obtained through a set of APIs (application programming interfaces) to query for specific information. Examples of social data include, by way of illustration and not limitation, a social group (whether or not the group is associated with the computer user); a set of restaurants “liked” by a group of friends; the most popular local hiking trails; and the like. In some instances, the social data obtained (either from an external party or available to the search engine 110) may constitute a set of search results. In other words, the search results responsive to the search query may be obtained from an external social source as social data.

As mentioned above, a social source operation is an expression that qualifies the subject matter of a search query, i.e., the query topic, based on information relating to one or more other people (a social source.) Typically, but not always, a social source operation is comprised of operators and operands relating to or identifying a social source. In one embodiment, a social source operation is represented in the following syntax:

[scope].filter condition value

where “scope” is optional (as indicated by the brackets “[ ]”) and could any one of a social network, an group of people having identified or identifiable members (e.g., friends, people who like - - - , neighbors, and the like), an group of people having particular attributes but not identifiable members, and the like. The scope may identify a domain or, alternatively, identify a domain and subdomains. Examples of scope may include, but not limited to: Facebook; Foursquare; Yelp; a subscription list; a computer user's friends; people in the computer user's neighborhood; a computer user's friends on Facebook; and the like.

“Filter” identifies a common characteristic of the targeted group/scope. Examples of “filter” include, by way of illustration and not limitation: check-in status; like status; votes; reviews; trends; and the like. “Condition” corresponds to relational comparisons/threshold conditions including, by way of illustration and not limitation: greater than, “>”; less than, “<”; equality, “=”; greater than or equal to, “>=”; less than or equal to, “<=”; unions; intersections; and the like. “Value” corresponds to a definite value, such as but not limited to a numeric value, a Boolean value, yes/no, a set of predetermined responses (e.g., a particular color), and the like. The following table, Table 1, illustrates an exemplary, non-limiting set of filtering conditions.

TABLE 1

| Condition | Example | Description |
|---|---|---|
| contains: | contains:pdf | Restricts search results to those with specified file types |
| | | (pdf) |
| domain: | domain:microsoft.com | Limits the search results to a specific domain |
| | | (microsoft.com) |
| filetype: | filetype:xls | Return only those search results having the specified file |
| | | extension (xls) |
| feed: | feed:fishing | Return RSS or other data feeds corresponding to the |
| | | specified term (fishing) |
| imageSize: | dogs imagesize:large | Constrains the size of images (large) returned in response |
| | | to a query (dog) |
| inanchor: | inachor:Alaska | Return only those search results having the specified term |
| | | (Alaska) in the anchor text |
| inbody: | inbody:“scuba diving” | Return only those search results having the specified term |
| | | (scuba diving) in the body of the document |
| instreamset: | instreamset:(url | Return only those search results having the specified term |
| | title):foo | (foo) in the specified document part (URL title) |
| intitle: | intitle:zombies | Return only those search results having the specified term |
| | | (zombies) in the title of the document/URL |
| keyword: | keyword:(title body) | Filters search results to the specified document parts (title |
| | Porsche | and body) containing the specified keyword (Porsche) |
| literalmeta | literalmeta:foo(dinner) | Filters search results to those with a specified meta-tag |
| | | (foo) that includes a specified term (dinner) |
| near: | foo near:10 bar | Filters search results to those where a second term (bar) is |
| | | within a specified distance (10) of a first term (foo) |

As indicated, a search query may include more than one social source operations. Indeed, multiple social source operations, including both filtering and sorting operations, may be combined by way of logical operators (or combinations of logical operators) including conjunctions (“and”), disjunctions (“or” and “exclusive or”, unions, and intersections. Moreover, social source operations may be modified via Boolean operators, e.g., “not.” Additionally, a “sort” operation may also be included in the search query. The sort operation identifies to the search engine the basis for sorting the relevant search results. An exemplary syntax, for illustration purposes, may include “sort:[scope.]name” where “sort:” is the operation indicator, “scope” identifies an optional scope of applicability, and “name” identifies the basis for sorting.

Search queries that include explicitly identified social source operations will typically include a query topic, i.e., the subject matter of the search query. The search engine 110 identifies search results corresponding to the query topic as modified by the one or more social source operations. The search engine 110 may consider the modifications of the social source operations in ranking and sorting search results responsive to the search query.

Examples of search queries that include a social source operation include, by way of illustration and not limitation: “pizza restaurant facebook.checkin>10” where “pizza restaurant” is the query topic and indicating a search for pizza restaurants where there have been at least 10 check-ins by people on Facebook; “pizza restaurant friends.checkin>=5” indicating a search for pizza restaurants wherein have been at least 5 check-ins by the requesting computer user's friends; “pizza restaurant like>50” indicating a search query for pizza restaurants each having over 50 likes by various (but undefined) computer users; and “Italian restaurant yelp.reviews>10 sort:yelp.reviews.score” indicating a search for Italian restaurants having at least 10 Yelp reviews and sorting the corresponding results according to the Yelp review scores.

As already mentioned, the disclosed matter should not be construed as being limited to a specific syntax, including those mentioned above. Those skilled in the art will appreciate that there are any number of ways in which a social source operations may be expressed. Accordingly, while the above examples illustrate some embodiments of a syntax in which social source operations may be expressed, they are illustrative only and not limiting.

To better appreciate how the search engine 110 responds to search queries that include social source operations, reference is made to FIG. 2. FIG. 2 is a block diagram 200 illustrating the flow of information between various components, including the computer user 101, the search engine 110 and one or more social sites 116, with regard to a search query 201 that includes one or more social source operations. As shown, a computer user 101 submits a search query 201 to a suitably configured search engine 110 over a network 108 by way of user computer 102. Upon receipt, a query parsing component 204 of the search engine 110 examines the search query to determine whether the search query includes one or more social source operations. For illustration purposes, the following discussion will assume that the search query includes at least one social source operation.

According to aspects of the disclosed subject matter, the query parsing component 204 performs an analysis on the search query 201 to determine whether there is a social source operation and, if so, what information must be obtained from external social sources and what information is available within the control of the search engine. For example, a social source operation may specify information that is available from an external network site, such as a social site. For example, if the computer user specifies a scope such as “facebook.friends.checkin>5” such information would likely then be obtained via a Facebook API (application programming interface) for obtaining such information. On the other hand, a social source operation may specify information that is available to the search engine. For example, if the computer user specifies a scope such as “friends checkin>5” such information may be readily available within the information that the search engine 110 maintains. Thus, in addition to identifying the presence of a social source operation, the various sources needed to satisfy the search query are identified and query information 203 is provided to these sources. As shown in FIG. 2, for illustration purposes the query information is provided to both a search results retrieval component 208 as well as a social data retrieval component 206. The search results retrieval component uses the query information 203 to retrieve search results 211 from a content store 210 that is maintained by the search engine 110. The social data retrieval component 206 accesses the necessary external social sites, such as social site 116, to obtain social information 207 responsive to the social source operation(s). The search results 211 obtained by the search results retrieval component 208 and the social information 207 obtained by the social data retrieval component 206 are provided to a search results combination component 212 where the social data 207 is applied to the search results 211 to yield a filtered and/or sorted set of search results 213 that satisfies the search query, including any social source operations. This set of search results 213 is then provided to a search results page generator 214 that generates one or more search results pages 215 (SERPs) and returns at least one search results page to the computer user 201.

It should be appreciate that the various search engine components described above, including the query parsing component 204, the social data retrieval component 206, the search results retrieval component 208, the search results combination component 212, and the search results page generator 214 represent logical components for carrying out various functionality, and may or may not directly correspond to actual components in a suitably configured search engine. Moreover, other components that are not identified may be included in a suitably configured search engine 110. In an actual embodiment, the various components identified in FIG. 2 may be combined together or distributed among various components in any number of configurations. Further still, the logical components may be implemented on a single computing device and/or platform, or distributed on a network 108 as cooperative processes.

While a computer user 101 may often prefer to explicitly identify a social source operation to be performed, as previously indicated a social source operation may be inferred from a particular context or factor. For example, under some circumstances when a computer user, such as computer user 101, has an active connection to a social site, such as Facebook, Foursquare, Google+, and the like, it may be advantageous to infer a “generic” social source operation with regard to any search query that the computer user may submit. For example, if a computer user 101 maintains a connection (i.e., remains logged on) to Facebook when submitting a search query, as part of submitting the search query a social source operation that sorts search results according to preferences of the computer user's social group obtained from Facebook may be implicitly included as part of the search query. Alternatively, if the computer user 101 is actively interacting with content on a social site, any search query executed on the site may include a social source operation that filters and/or sorts search results according to preferences of the computer user's social group on the social site. Further still, as a computer user 101 submits a search query, as part of submitting the search query a determination may be made that checks whether the computer user is maintaining a connection with a social site and, if so, the entire search query is redirected to the social site where results are retrieved with an implicit social source operation to filter and/or sort the results according to the likes and preferences of the computer user's social network.

Further still, while much of this discussion is made in regard to a social source operation that identifies a single source of social data, this should be viewed as illustrative and not limiting upon the disclosed subject matter. Indeed, a social source operation may identify multiple sources of social data to be used in evaluating a search query. For example, a search query directed to restaurants where a computer user's co-workers often frequent (as determined by check-ins on a social site) for lunch may include a social source operation that obtains check-in data for restaurants from a first social site and co-worker data from a second social site.

Turning now to FIG. 3, FIG. 3 is a flow diagram illustrating an exemplary routine 300 for responding to a search query from a computer user where the search query includes a social source operation. Beginning at block 302, a search query 201 is received from a computer user 101. At block 304, search results 211 responsive to the query topic of the search query are obtained. At block 306, social data 207 that is needed to complete the social source operation included in the search query 201 is obtained. Social data 207 may be obtained from external sources including social sites, such as social site 116, or determined by the search engine 110. At block 308, the obtained search results 211 and the social data 207 are combined. The combination of the search results 211 and the social data 207 is, at least in part, the result of executing the social source operation of the search query. For example, assuming the social source operation is “pizza restaurant facebook.checkin>10”, then the obtained search results 211 corresponding to pizza restaurants are filtered according to the social data 207 obtained from the social site, Facebook, identifying restaurants having more than 10 check-ins. Indeed, for this example, it can be readily seen that all of the search results could be obtained from the social site identified in the social source operation simply by passing the query topic, “pizza restaurant,” to the social site along with the condition, “checkin>10.”

As mentioned above, the results of combining the search results 211 and social data 207 is a revised set of search results 213. Thus, at block 310, one or more search results pages 215 are generated based on the revised set of search results 213. Thereafter, at block 314, at least one of the generated search results pages 215 are returned to the computer user in response to the search query.

With regard to combining the search results in view of the social source operation, while in at least one embodiment this implies filtering a set of search results in light of the constraints imposed by the social source operation, the disclosed subject matter is not so limited. In alternative embodiments, the results of the social source operation may serve as a ranking signal for determining the relevancy of various potential search results with regard to the search query. Further still, the results of a social source operation may serve as a sorting signal for ordering search results that are identified as being relevant to the search query. Indeed, a social source operation, or a combination of social source operations, may operate to filter, order, and identify as relevant search results in a single search query. Accordingly, “satisfying” a social source operation should be interpreted as executing or completing the social source operation with regard to the search query and may include: determining or enhancing the relevancy of search results; ordering/sorting the search results; and/or filtering the search results.

While novel aspects of the disclosed subject matter are expressed in regard to routines (such as routines 300 or 500 discussed below), processes, applications (also referred to as computer programs), and/or methods, these aspects may also be embodied as computer-executable instructions stored in computer-readable media (also referred to as computer-readable storage media). As those skilled in the art will appreciate, computer-readable media can host computer-executable instructions for later retrieval and execution. When executed on a computing device, the computer-executable instructions stored on one or more computer-readable storage devices carry out various steps, methods and/or functionality, including those steps, methods, and routines described in regard to routines 300 and 500. Examples of computer-readable media include, but are not limited to: optical storage media such as Blu-ray discs, digital video discs (DVDs), compact discs (CDs), optical disc cartridges, and the like; magnetic storage media including hard disk drives, floppy disks, magnetic tape, and the like; memory storage devices such as random access memory (RAM), read-only memory (ROM), memory cards, thumb drives, and the like; cloud storage (i.e., an online storage service); and the like. For purposes of this disclosure, however, computer-readable media expressly excludes carrier waves and propagated signals.

Turning now to FIG. 4, this figure is a block diagram illustrating exemplary components of a search engine 110 suitably configured to respond to a search query 201 from a computer user 101, where the search query includes a social source operation. The search engine 110 includes a processor 402 (or processing unit) and a memory 404 interconnected by way of a system bus 410. As those skilled in the art will appreciated, memory 404 typically (but not always) comprises both volatile memory 406 and non-volatile memory 408. Volatile memory 406 retains or stores information so long as the memory is supplied with power. In contrast, non-volatile memory 408 is capable of storing (or persisting) information even when a power supply is not available. Generally speaking, RAM and CPU cache memory are examples of volatile memory whereas ROM and memory cards are examples of non-volatile memory.

The processor 402 executes instructions retrieved from the memory 404 in carrying out various functions, including the function of responding to search queries that include social source operations. The processor 402 may be comprised of any of various commercially available processors such as single-processor, multi-processor, single-core units, and multi-core units. Moreover, those skilled in the art will appreciate that the novel aspects of the disclosed subject matter may be practiced with other computer system configurations, including but not limited to: mini-computers; mainframe computers, personal computers (e.g., desktop computers, laptop computers, tablet computers, etc.); handheld computing devices such as smartphones, personal digital assistants, and the like; microprocessor-based or programmable consumer electronics; and the like.

The system bus 410 provides an interface for search engine's components to inter-communicate. The system bus 410 can be of any of several types of bus structures that can interconnect the various components (including both internal and external components). The illustrative search engine 110 further includes a network communication component 412 for interconnecting the search engine with other computers (such as user computers 102-106 and networking sites 112-116) as well as other devices on a computer network 108. The network communication component 412 may be configured to communicate with an external network, such as network 108, via a wired connection, a wireless connection, or both.

As discussed above, a query parsing component 204 identifies a social source operation in a search query 201 and provides search data 203 to both a search results retrieval component 208 and a social data retrieval component 206. The search results retrieval component 208 identifies search results responsive to the search engine 110 receiving a search query 201 from a computer user 101. The search engine 110 identifies the search results according to information in the content store 210. The content store 210 includes information regarding content distributed throughout many locations on the network 108. Typically, but not exclusively, the content store 210 is indexed according to many keys which may include the query topic of the search query.

A social data retrieval component 206 obtains social data 207 necessary to complete the social source operation specified in the search query 201. The social data retrieval component 206 may obtain the social data 207 from external sources or from internally available data including user settings and preferences. A search results combination component 212 combines the search results 211 obtained from the search results retrieval component 208 and the social data 207 obtained from the social data retrieval component 206 to produce a revised set of search results 213. Combining the search results 211 and the social data 207 includes applying and/or executing the social source operation of the search query to the search results 211 in light of the social data 207, thereby producing a revised set of search results 213.

The search results page generator 214 generates one or more search results pages that may be presented to the requesting computer user 101 in response to the received search query 201. The search results page generator 214 generates the search results pages based on the revised search results 213 obtained from the search results combination component 212.

Those skilled in the art will appreciate that the various components described above, including (but not limited to) the query parsing component 204, the social data retrieval component 206, the search results retrieval component 208, the search results page generator 214, and the search results combination component 212 may be implemented as executable software modules within the search engines 110, as executable hardware modules, or a combination of the two. Moreover, each of the various components may be implemented as an independent, cooperative process or device, operating in conjunction with the search engine 110. It should be further appreciated, of course, that the various components described above in regard to the search engine 110 should be viewed as logical components for carrying out the various described functions. As those skilled in the art appreciate, logical components (or subsystems) may or may not correspond directly in a one-to-one manner to actual components. In an actual embodiment, the various components identified as being part of the search engine 110 in FIG. 4 may be combined together or broke up across multiple actual components and/or implemented as cooperative processes on a computer network 108.

Whereas in routine 300 the computer user 101 provides one or more explicit social source operations with the search query, as discussed above there may be occasions in which a social source operation may be implied, particularly when the computer user is maintaining a connection (i.e., is logged in) to one or more social sites. FIG. 5 shows a flow diagram illustrating an exemplary alternative routine (alternative to routine 300 of FIG. 3) for responding to a search query from a computer user with conditions for implying one or more social source operations. Beginning at block 502, a search query 201 is received from a computer user 101. At block 504, search results 211 responsive to the query topic of the search query 201 are obtained.

At block 506, any social sites from which social data should be obtained are identified. As suggested above, the social sites are identified according to contextual information, i.e., that the computer user is maintaining a connection (logged on) to one or more social sites. In other words, when conditions exist in the current context, an implicit social source operation may be implied to the search query. Further still, a user may have previously established preferences that indicate one or more social sites from which a search engine 110 may draw social data or, conversely, social sites that search engine should exclude in regard to obtaining social data.

As previously suggested, social sites may be accessed according to the type of social data that is needed to satisfy a search query 201. Stated differently, the search engine 110 makes one or more determinations as to which social sites have social data that is most germane to the implicit (or explicit) social source operations. These determinations may be based on the established preferences, on the computer user's search history, current connections to social sites, and the like. Moreover, the computer user may be contemporaneously queried by the system regarding the social sources from which social data is to be obtained. FIG. 6 is a pictorial diagram illustrating an exemplary user interface 600 showing an example of contemporaneous queries to determine a social source for data. More particularly, during entry of a search query, as it is determined that there are potentially one or more implicit social source operations (i.e., favorite pizza and the identity of “co-workers”), a contemporaneous query view 604 is displayed to assist the search engine 110 in determining the social site from which social data should be obtained in order to satisfy the search query. In the illustrated example, as the computer user 101 enters the search query, “Favorite pizza of co-workers,” in the search query text box 602, a contemporaneous query is presented (via the contemporaneous query view 604) to ask the computer user as to which source the search engine 110 should use to identify the individuals that are “co-workers”. As illustrated, there may be several sources from which a search engine 110 may obtain relevant social data, including (by way of illustration only) selectors 606-610 for corresponding social sites.

As previously mentioned, social data may be obtained from one or more social sites. By way of example, for information regarding a computer user's social group, a search engine 110 may obtain social data Facebook or similar sites. In contrast, to determine check-in information the search engine 110 may obtain social data from Foursquare. Similarly, work-related data may best be obtained from LinkedIn. User preferences as to the sources of social data may also be consulted. Thus, according to various embodiments of the disclosed subject matter, social data is selectively obtained from social sites according to the type of social data that is useful to fully satisfy a search query from the computer user. Thus, at block 508 the social data from the identified one or more social sites is obtained. Of course, explicitly identified social source operations may also be included in the search query and social data from the corresponding social site would also be obtained.

Returning again to FIG. 5, after having obtained the social data, at block 510, the obtained search results 211 and the social data 207 are combined. The combination of the search results 211 and the social data 207 is, at least in part, the result of executing one or more implicit (and possibly explicit) social source operations of the search query. As suggested, the result of combining the search results 211 and obtained social data 207 is a revised set of search results 213. Thus, at block 512, one or more search results pages 215 are generated based on the revised set of search results 213. Thereafter, at block 514, at least one of the generated search results pages 215 are returned to the computer user in response to the search query.

While various novel aspects of the disclosed subject matter have been described, it should be appreciated that these aspects are exemplary and should not be construed as limiting. Variations and alterations to the various aspects may be made without departing from the scope of the disclosed subject matter.

What is claimed:

1. A computer-implemented method for responding to a search query from a computer user, the method comprising:
receiving a search query from a computer user, the search query identifying a query topic and a social source operation;
obtaining a set of search results corresponding to the query topic of the search query and that satisfies the social source operation;
generating a search results page including the obtained set of search results; and
returning the generated search results page to the computer user.

2. The computer-implemented method of claim 1, wherein the social source operation identifies an external social service from which to obtain social data to satisfy the social source operation.

3. The computer-implemented method of claim 2, wherein obtaining the set of search results comprises obtaining the set of search results from the external social service.

4. The computer-implemented method of claim 2, wherein obtaining the set of search results comprises:
obtaining a set of search results from a content store;
obtaining social data from the external social service; and
applying the social source operation to the obtained search results according to the obtained social data.

5. The computer-implemented method of claim 2, wherein the social source operation identifies a social group associated with computer user available via the external social service.

6. The computer-implemented method of claim 2, wherein the social source operation further identifies a social group available via the external social service.

7. The computer-implemented method of claim 2, wherein the social source operation further identifies criteria for members of an undefined group of people.

8. The computer-implemented method of claim 1, wherein the social source operation comprises a filtering operator for filtering search results corresponding to the query topic according to social data identified in the social source operation.

9. The computer-implemented method of claim 1, wherein the social source operation comprises a sorting operator for sorting search results corresponding to the query topic according to social data identified in the social source operation.

10. A computer-readable medium bearing computer-executable instructions which, when executed on a computing system comprising at least a processor executing the instructions retrieved from the medium, carry out a method for responding to a search query from a user, the method comprising:
receiving a search query from a computer user, the search query identifying a query topic and a social source operation;
obtaining a set of search results corresponding to the query topic of the search query and that satisfies the social source operation;
generating a search results page including the obtained set of search results; and
returning the generated search results page to the computer user.

11. The computer-readable medium of claim 10, wherein the social source operation identifies an external social service from which to obtain social data to satisfy the social source operation.

12. The computer-readable medium of claim 11, wherein obtaining the set of search results comprises obtaining the set of search results from the external social service.

13. The computer-readable medium of claim 11, wherein obtaining the set of search results comprises:
obtaining a set of search results from a content store;
obtaining social data from the external social service; and
applying the social source operation to the obtained search results according to the obtained social data.

14. The computer-readable medium of claim 11, wherein the social source operation identifies a social group associated with computer user available via the external social service.

15. The computer-readable medium of claim 11, wherein the social source operation further identifies a social group available via the external social service.

16. The computer-readable medium of claim 10, wherein the social source operation comprises a filtering operator for filtering search results corresponding to the query topic according to social data identified in the social source operation.

17. The computer-readable medium of claim 10, wherein the social source operation comprises a sorting operator for sorting search results corresponding to the query topic according to social data identified in the social source operation.

18. A computer-implemented method for responding to a search query from a computer user, the method comprising:
receiving a search query from a computer user, wherein the search query identifies a query topic and requires a social source operation to fully satisfy the search query;
determining that a social source operation should be implied to satisfy the search query;
obtaining social data from a social site according to the implied social source operation;
obtaining a set of search results corresponding to the query topic of the search query;
applying the social source operation to the obtained search results according to the obtained social data;
generating a search results page including the obtained set of search results; and
returning the generated search results page to the computer user.

19. The computer system of claim 21, wherein determining that a social source operation should be implied to satisfy the search query comprises determining that the computer user is maintaining a connection to the social site.

20. The computer system of claim 21, wherein determining that a social source operation should be implied to satisfy the search query comprises determining that the computer user has established a preference to obtain social data from a social site.
